(19) United States
(12) Patent Application Publication
(10) Pub. No.: US 2015/0020578 A1
(43) Pub. Date: Jan. 22, 2015

(54) APPARATUS FOR INSPECTING LEAK OF BATTERY AND METHOD OF INSPECTING LEAK OF BATTERY USING THE APPARATUS

(71) Applicant: Samsung SDI Co., Ltd., Yongin-si (KR)

(72) Inventors: Hwan Kim, Yongin-si (KR); Jin-Pil Kim, Yongin-si (KR)

(21) Appl. No.: 14/322,821

(22) Filed: Jul. 2, 2014

(30) Foreign Application Priority Data
Jul. 17, 2013 (KR) 10-2013-0084372

(51) Int. Cl. G01M 3/36

(52) U.S. Cl. CPC G01M 3/363
USPC 73/40

(57) ABSTRACT

An apparatus for inspecting a leak of a battery, the apparatus including a jig on which a battery is mounted, a first plate comprising nozzle parts configured to inject air, a second plate configured to support the jig and the first plate, and a first driving unit positioned on the second plate and configured to move the jig, wherein the jig is moved by the first driving unit to a position at which the jig overlaps the first plate.

### CROSS-REFERENCE TO RELATED APPLICATION

This application claims priority to and the benefit of Korean Patent Application No. 10-2013-0084372, filed on Jul. 17, 2013, in the Korean Intellectual Property Office, the disclosure of which is incorporated herein in its entirety by reference.

### BACKGROUND

1. Field

One or more embodiments of the present invention relate to an apparatus for inspecting a leak of a battery and a method of inspecting a leak of a battery using the apparatus.

2. Description of the Related Art

A secondary battery is a battery that can be repeatedly charged/discharged, unlike a primary battery that cannot be recharged. As laptop computers or mobile communication devices are becoming ubiquitous, the secondary battery is being widely used as a power supply unit for laptop computers or mobile communication devices.

The secondary battery has a configuration in which an anode plate, a separator, and a cathode plate are sequentially stacked and wound together with the anode plate in the form of a jelly roll, and sealed within a case together with an electrolyte. In the secondary battery, ions generated in the electrolyte are moved between an anode and a cathode such that an electromotive force is generated and a charging/discharging operation is performed due to the electromotive force.

Thus, when the electrolyte leaks from the secondary battery, a charging/discharging capacity of the secondary battery is affected by the leak. In a secondary battery manufacturing process line, a leak of a manufactured secondary battery can be inspected.

Methods of inspecting a leak of the secondary battery include a method of detecting an electrolyte exposed to the outside using a smell sensor, a method of checking the occurrence of swelling by putting the secondary battery into a sealed chamber, pressurizing an inside of the chamber and blowing air, and the like.

However, in the method of detecting the electrolyte exposed to the outside using the smell sensor, when the electrolyte is once exposed to the outside, air inside an inspection apparatus must be exchanged for next inspection; and when air inside or outside the inspection apparatus is contaminated, a detection ability of the inspection apparatus is reduced. Further, there is a limitation in inspecting a plurality of secondary batteries. Also, in the method of checking the occurrence of swelling by putting the secondary battery into a sealed chamber, a means for pressurizing the inside of the chamber and blowing air, and equipment, such as a chamber, high-pressure compressor, and the like, must be provided, and there is a risk that a safety accident will occur due to high pressure.

### SUMMARY

One or more embodiments of the present invention are directed to an apparatus for inspecting a leak of a battery having a simple configuration and an improved battery leak detection ability and a method of inspecting a leak of the battery using the apparatus.

Additional aspects will be set forth in part in the description which follows and, in part, will be apparent from the description, or may be learned by practice of the presented embodiments.

According to one or more embodiments of the present invention, there is provided an apparatus for inspecting a leak of a battery, the apparatus including: a jig on which a battery is mounted; a first plate including nozzle parts configured to inject air; a second plate configured to support the jig and the first plate; and a first driving unit positioned on the second plate and configured to move the jig, wherein the jig is moved by the first driving unit to a position at which the jig overlaps the first plate.

The nozzle parts may be configured to inject air in a direction of the jig when the jig overlaps the first plate.

Each of the nozzle parts may include a plurality of nozzle holes, and the plurality of nozzle holes may be positioned to be spaced from each other by a gap.

A horizontal cross-section of each of the nozzle holes may be tapered in a direction of air injection.

The battery may include an electrode assembly and a pouch accommodating the electrode assembly, the pouch may include a pair of side wing parts and a terrace part formed by fusion bonding, and the plurality of nozzle holes may be positioned to inject the air onto at least the pair of side wing parts and the terrace part.

The pair of side wing parts may be bent in one direction, concave parts may be between the pair of side wing parts and sides of the battery, and the nozzle holes may be positioned to correspond to positions of the concave parts.

The jig may include a mounting part, and the battery may be mounted within the mounting part.

The jig may include a plurality of mounting parts.

The apparatus may further include a second driving unit configured to adjust a height of the first plate.

The apparatus may further include a guide part positioned on the second plate for limiting a movement range of the jig.

The jig may be positioned below the first plate to overlap the first plate.

The nozzle parts may inject the air under an atmospheric pressure.

According to one or more embodiments of the present invention, there is provided a method of inspecting a leak of a battery, the method including: mounting a battery on a jig; moving the jig to overlap a first plate including nozzle parts; and injecting air onto the battery using the nozzle parts, wherein the battery includes a pouch accommodating an electrode assembly, the pouch includes a pair of side wing parts and a terrace part formed by fusion bonding, and the nozzle parts are configured to inject the air onto at least the pair of side wing parts and the terrace part.

The nozzle parts may inject the air under an atmospheric pressure.

A plurality of nozzle holes may be formed in each of the nozzle parts, and a horizontal cross-section of each of the nozzle holes may be tapered in a direction of air injection.

The pair of side wing parts may be bent in one direction, concave parts may be formed between the pair of side wing parts and sides of the battery, and the air may be injected onto the concave parts.

A mounting part may be on the jig, and the battery may be mounted within the mounting part.

A plurality of mounting parts may be on the jig.

The method may further include adjusting a height of the first plate before injecting the air.

The method may further include determining whether a leak occurs in the battery based on swelling of the battery after injecting the air.

### BRIEF DESCRIPTION OF THE DRAWINGS

These and other aspects will become apparent and more readily appreciated from the following description of the embodiments, taken in conjunction with the accompanying drawings of which:

FIGS. 1 and 2 are perspective views schematically illustrating an apparatus for inspecting a leak of a battery, according to an embodiment of the present invention;

FIG. 3 is a perspective view schematically illustrating a battery mounted on the apparatus illustrated in FIG. 1, according to an embodiment of the present invention;

FIG. 4 is a cross-sectional view taken along a line A-A′ of the battery of FIG. 3, according to an embodiment of the present invention;

FIG. 5 is a perspective view schematically illustrating a part of the apparatus of FIG. 1, according to an embodiment of the present invention;

FIG. 6 is a cross-sectional view schematically illustrating a method of inspecting a leak of a battery, according to an embodiment of the present invention; and

FIGS. 7 through 9 are cross-sectional views schematically illustrating nozzle holes of the apparatus of FIG. 1, according to an embodiment of the present invention.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first,” “second,” etc., may be used to describe various components, such components must not be limited to the above terms. The above terms are used only to distinguish one component from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

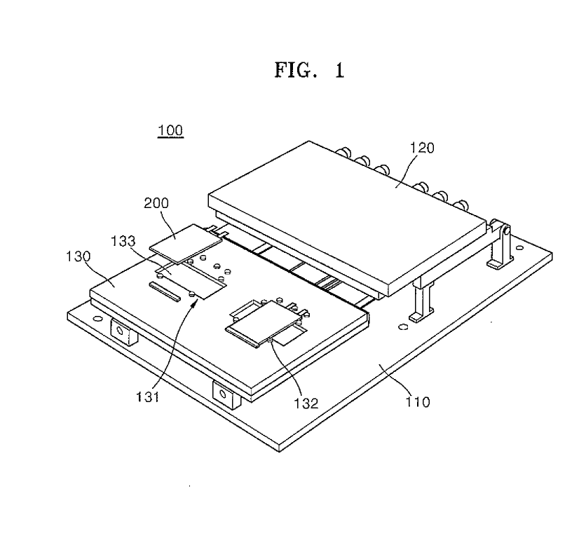

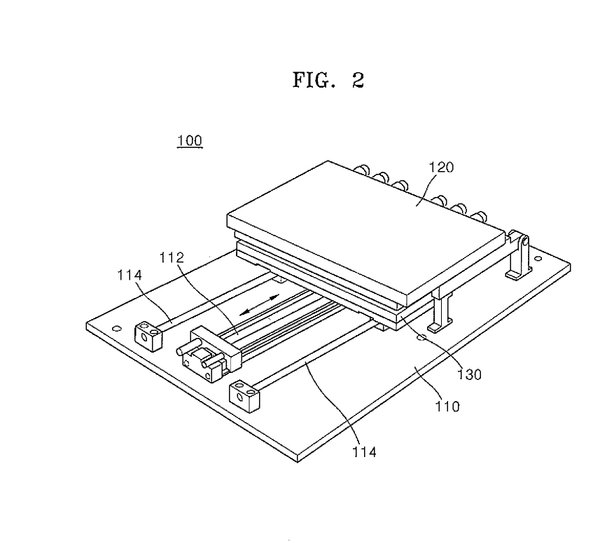

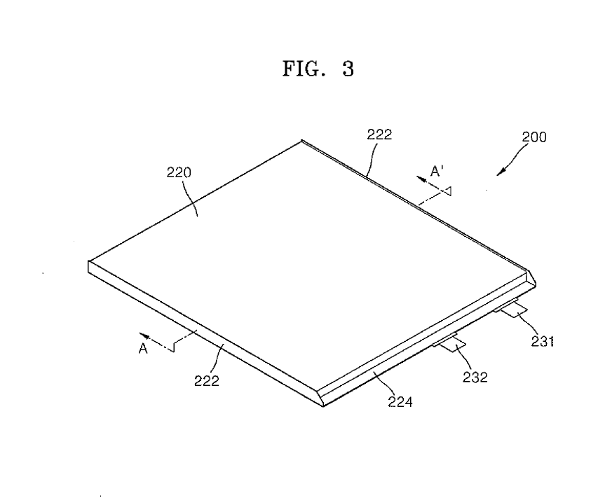

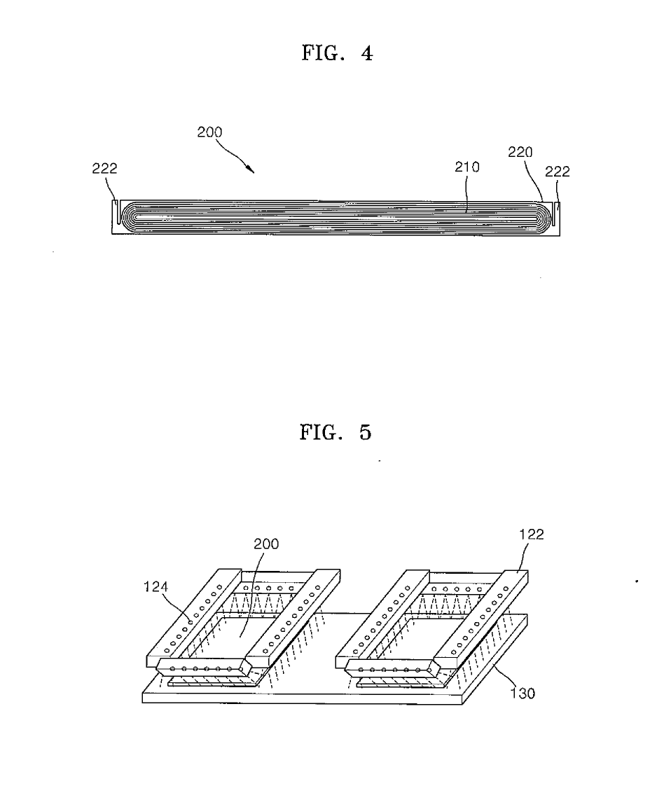

FIGS. 1 and 2 are perspective views schematically illustrating an apparatus for inspecting a leak of a battery, according to an embodiment of the present invention. FIG. 3 is a perspective view schematically illustrating a battery mounted on the apparatus illustrated in FIG. 1, according to an embodiment of the present invention. FIG. 4 is a cross-sectional view taken along a line A-A′ of the battery of FIG. 3, and FIG. 5 is a perspective view schematically illustrating a part of the apparatus of FIG. 1, according to some embodiments of the present invention.

Referring to FIGS. 1 and 2, an apparatus 100 for inspecting a leak of a battery 200, according to an embodiment of the present invention, includes a jig 130 on which the battery 200 is mounted, a first plate 120 having nozzle parts 122 (see e.g., FIG. 5) that inject air, a second plate 110 that supports the jig 130 and the first plate 120, and a first driving unit 114 that moves the jig 130. The apparatus 100 for inspecting the leak of the battery illustrated in FIGS. 1 and 2 may further include a second driving unit that adjusts a height of the first plate 120 and a guide part 112 that limits a movement range of the jig 130.

The second plate 110 is a supporting plate that supports the jig 130, the first plate 120, the first driving unit 114, and the guide part 112.

The battery 200 is mounted on the jig 130, and a leak of the battery 200 due to air injected by the first plate 120 is inspected.

The battery 200 may include an electrode assembly 210 and a pouch 220 that seals the electrode assembly 210, as illustrated in FIGS. 3 and 4. Also, an electrolyte is sealed within the pouch 220 together with the electrode assembly 210. Also, the battery 200 may further include a protection circuit module (PCM). The protection circuit module may be electrically connected to a first electrode terminal 231 and a second electrode terminal 232 so as to prevent the battery 200 from overheating and exploding due to overcharge, overdischarge, or overcurrent. The protection circuit module may, for example, be placed on a terrace part 224.

The electrode assembly 210 may include a cathode plate and an anode plate that are coated with an electrode active material, and a separator interposed between the cathode plate and the anode plate. For example, the electrode assembly 210 may be manufactured by forming a stacked structure in which the cathode plate, the separator and the anode plate are sequentially stacked and then by winding the stacked structure in the form of a jelly roll. However, aspects of the present invention are not limited thereto. In another embodiment, the electrode assembly 210 may have a stacked structure in which the cathode plate, the separator and the anode plate are sequentially stacked.

The pouch 220 may accommodate the electrode assembly 210 and may include a pair of side wing parts 222 and the terrace part 224 formed by fusion bonding. For example, when an accommodation space in which the electrode assembly 210 may be accommodated is formed in one region of the pouch 220 and the electrode assembly 210 is accommodated in the accommodation space, the other region of the pouch 220 that is successively formed with one region of the pouch 220 is folded to cover the accommodation space. Thus, one region and the other region of the pouch 220 overlap each other and constitute top and bottom surfaces of the pouch 220.

One region and the other region of the pouch 220 that overlap each other are fusion bonded to each other at edges of the accommodation space thus, sealing the electrode assembly 210. Further, the fusion-bonded edges of the accommodation space constitute the pair of side wing parts 222 and the terrace part 224.

Also, the pair of side wing parts 222 is bent in one direction. For example, the pair of side wing parts 222 is bent toward sides of the battery 200 so that concave parts may be formed between the pair of side wing parts 222 and sides of the battery 200.

When a leak occurs in the pouch 220, the electrolyte leaks to the outside, thus creating a risk of heat dissipation caused by a chemical reaction of the leaking electrolyte and explosion thereby. Thus, the battery 200 in which the leak occurs is considered a defective battery.

Referring back to FIGS. 1 and 2, a mounting part 131 on which the battery 200 is to be mounted, is formed on the jig 130.

The mounting part 131 may include protrusions 132 that protrude according to the shape of the battery 200 and a groove 133 defining a hollow underneath the battery 200.

The protrusions 132 may contact the sides of the battery 200 so as to fix the position of the battery 200 when the jig 130 is moved or air is injected by the first plate 120. The groove 133 causes the occurrence of eddy current in the lower part of the battery 200 when air is injected onto one side (e.g., a top side) of the battery 200 as will be described below. Thus, even when a leak occurs on the other side (e.g., a bottom side) of the battery 200, a leak of the battery 200 may be inspected.

A plurality of mounting parts 131 may be formed on the jig 130. Thus, the apparatus 100 for inspecting the leak of the battery 200 may inspect a plurality of batteries 200 simultaneously, and the overall inspection time of the battery 200 may be reduced.

The first driving unit 114 may be placed on the second plate 110 and may be fastened to a lower part of the jig 130 so as to move the jig 130. For example, the first driving unit 114 may include a pair of ball screws positioned in parallel to each other and a motor for rotating the pair of ball screws.

A guide part 112 may be further formed on the second plate 110. The guide part 112 may be configured to stop the jig 130 when the jig 130 moved by the first driving unit 114 is moved to a position at which the jig 130 overlaps the first plate 120. Also, shock absorbing members may be formed at both ends of the guide part 112 so as to stop the moving jig 130 and simultaneously to absorb a shock.

When the jig 130 overlaps the first plate 120, the first plate 120 injects air onto the jig 130. For example, the first driving unit 114 may position the jig 130 under the first plate 120, thus, allowing the first plate 120 to inject air onto one side of the battery 200 mounted on the jig 130.

To this end, the first plate 120 may include nozzle parts 122 (see e.g., FIG. 5) that inject air. The nozzle parts 122 (see e.g., FIG. 5) may inject air onto one side of the battery 200 only or inject air intensively (e.g., at high speed/pressure) onto a part of the battery 200 that is vulnerable to leakage.

The first plate 120 may further include a second driving unit for adjusting the height of the first plate 120. The second driving unit may cause vertical movement of the first plate 120. For example, when the first plate 120 is moved upward while the jig 130 is moved and positioned below the first plate 120, a second driving unit moves the first plate 120 downward close to the jig 130. When air is injected at a position where the first plate 120 and the jig 130 are closer to each other, the pressure of air that reaches the surface of the battery 200 increases and a leak detection ability of the apparatus 100 may be improved (e.g., the probability of leak detection may increase).

When a leak occurs in the battery 200, injected air flows in the battery 200 through the leak, and swelling occurs in the surface of the battery 200. The occurrence of swelling may be determined by the naked eye; however, in order to automatically determine the occurrence of swelling, the apparatus 100 for inspecting the leak of the battery may further include a camera unit that captures an image of the surface of the battery 200 and a controller that may determine whether swelling occurs in the battery 200 based on the image captured by the camera unit.

FIG. 5 is a perspective view illustrating only the jig 130 on which the battery 200 is mounted, and only the nozzle parts 122 of the first plate 120 of the apparatus 100 of FIG. 1, according to an embodiment of the present invention.

Referring to FIG. 5 together with FIG. 2, the nozzle parts 122 may be placed at the lower part of (e.g., positioned under) the first plate 120 and may include a plurality of nozzle holes 124 through which air is injected onto the battery 200.

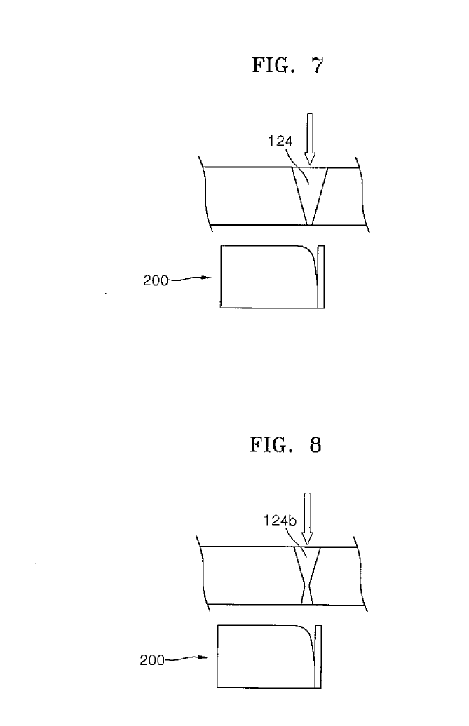

The plurality of nozzle holes 124 may be spaced from each other by a distance (i.e., a gap). For example, a distance between the plurality of nozzle holes 124 may be between about 2 mm and about 10 mm. However, aspects of the present invention are not limited thereto. The distance between the plurality of nozzle holes 124 may be set in various ways according to the shape of the nozzle holes 124 (which will be described below with reference to FIGS. 7 through 9) and a distance between the battery 200 and each of the nozzle parts 122.

The nozzle parts 122 may be configured to inject air onto an entire side of the battery 200. For example, a plurality of nozzle parts 122 may be positioned in parallel to each other and may inject air onto an entire side of the battery 200.

Alternatively, as illustrated in FIG. 5, the nozzle parts 122 may be positioned to correspond to a certain part of the battery 200. Here, the certain part of the battery 200 may refer to a part that is relatively vulnerable to leakage.

For example, FIG. 5 illustrates a configuration in which the nozzle parts 122 are positioned to correspond to edges of the battery 200. In the battery 200, as illustrated in FIGS. 3 and 4, the electrode assembly 210 and the electrolyte are sealed by the pouch 220 (see e.g., FIG. 3) which constitutes the pair of side wing parts 222 (see e.g., FIG. 3) and the terrace part 224 (see e.g., FIG. 3) formed by fusion bonding. The pair of side wing parts 222 (see e.g., FIG. 3) and the terrace part 224 (see e.g., FIG. 3) that are fusion bonded are areas that are relatively vulnerable to leakage compared to other parts of the battery 200. The nozzle parts 122 may be configured to intensively inject air (e.g., at high speed/pressure) onto the pair of side wing parts 222 (see e.g., FIG. 3) and the terrace part 224 (see e.g., FIG. 3).

In one embodiment, the pair of side wing parts 222 (see e.g., FIG. 3) are bent and constitute concave parts together with the sides of the battery 200. A probability that a leak will occur in the bent parts, is higher (e.g., increased) compared to other parts of the battery 200. Thus, the nozzle parts 122 may be positioned to correspond to the concave parts of the battery 200. For example, the nozzle holes 124 formed in the nozzle parts 122 may be located to correspond to positions of the concave parts so that air may be injected into the concave parts. Because the concave parts cause an increase in the pressure of air injected into the concave parts, when a leak occurs in the concave parts, the leak detection ability of the apparatus 100 may be improved.

The second driving unit may adjust the height of the first plate 120 when air is injected. For example, when air is injected, the distance between the nozzle part 122 and the battery 200 may be between about 1 mm and about 10 mm; however, aspects of the present invention are not limited thereto. The distance between the nozzle part 122 and the battery 200 may be set in various ways depending on the injection pressure of air and the arrangement of the nozzle parts 122. For example, an embodiment in which the nozzle parts 122 are configured to inject air onto an entire side of the battery 200 may be favorable as the distance between the nozzle part 122 and the battery 200 increases. On the other hand, an embodiment in which the nozzle parts 122 are configured (e.g., positioned) to correspond to a part of the battery 200, i.e., a part having a relatively high probability that a leak will occur in the battery 200, may be favorable as the distance between the nozzle part 122 and the battery 200 decreases.

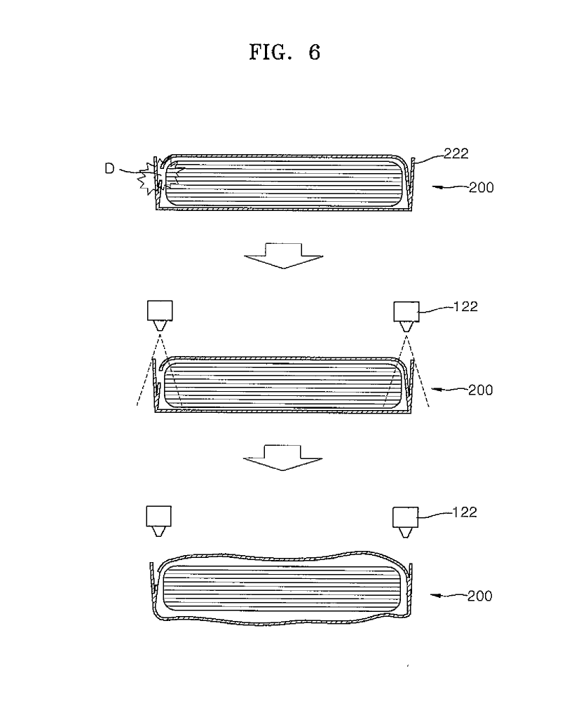

FIG. 6 is a cross-sectional view schematically illustrating a method of inspecting a leak of a battery, according to an embodiment of the present invention.

Hereinafter, the method of inspecting the leak of the battery 200, according to an embodiment of the present invention, will be briefly described with reference to

FIG. 6 together with FIGS. 1, 2, and 5. In FIG. 6, the nozzle parts 122 are positioned to correspond with the edges of the battery 200. However, aspects of the present invention are not limited thereto, and the nozzle parts 122 may inject air onto an entire side of the battery 200.

The method of inspecting the leak of the battery 200 illustrated in FIG. 6 includes mounting the battery 200 on the jig 130, moving the jig 130 to overlap the first plate 120 including the nozzle parts 122, and injecting air onto the battery 200 using the nozzle parts 122. Also, before injecting air, the height of the first plate 120 may be adjusted using the second driving unit.

The detailed description of mounting the battery 200 on the jig 130 and moving the jig 120 to overlap the first plate 120 is the same as that provided above with reference to FIGS. 1 and 2, and thus will not be repeated here.

Injecting air using the nozzle parts 122 may be performed under an atmospheric pressure. Thus, the apparatus 100 of FIG. 1 may not be equipped with a chamber and a high-pressure compressor for adjusting pressure inside the chamber. As a result, the configuration of the apparatus 100 of FIG. 1 may be simplified.

When a leak D occurs in the battery 200, air that is injected at high speed flows in the battery 200 through the leak D. In this case, the pressure of injected air may be between about 0.2 MPa and about 0.6 MPa.

When the pressure of injected air is less than 0.2 MPa, air may not be easily injected into the battery 200 through the leak D. On the other hand, when the pressure of injected air is greater than 0.6 MPa, the pouch 220 (see e.g., FIG. 3) having a part in which the leak D occurs may bend (e.g., buckle or recess) under air pressure and the leak D may be reduced or altogether clogged. Thus, the leak detection ability of the apparatus 100 may be lowered. Thus, it may be desired to inject air under the pressure of about 0.2 MPa to about 0.6 MPa.

When air is injected into the battery 200 through the leak D, swelling occurs on the surface of the battery 200, and it may be determined (e.g., visually determined) whether or not a leak D occurs in the battery 200 based on the occurrence of swelling or lack thereof.

The mounting part 131 on which the battery 200 is mounted, includes a groove 133 through which hollowness is formed in the lower part of the battery 200.

Thus, air injected from an upper part of the battery 200 creates (e.g., constitutes) eddy current in the groove 133 formed under the battery 200. Thus, when the leak D occurs in the lower part of the battery 200, air may flow into the leak D due to the eddy current. Thus, the apparatus 100 of FIG. 1 may detect not only a leak that occurs on one side of the battery 200 onto which air is injected but also a leak that occurs on another side of the battery 200 opposite to the one side so that the leak detection ability of the apparatus 100 may be improved.

FIGS. 7 through 9 are cross-sectional views schematically illustrating the nozzle holes 124 of the apparatus 100 of FIG. 1, according to some embodiments of the present invention. Although FIGS. 7 through 9 illustrate nozzle holes 124, 124b, and 124c having various shapes, aspects of the present invention are not limited thereto. The nozzle holes 124, 124b, and 124c may have other shapes than the shapes of FIGS. 7 through 9.

Referring to FIG. 7, a horizontal cross-section of the nozzle hole 124 may be tapered in an air injection direction. For example, the horizontal cross-section of nozzle hole 124 may have a funnel shape. Thus, the speed of injected air may be increased, and the occurrence of a leak may be more effectively inspected.

Referring to FIG. 8, the nozzle hole 124b may have a shape in which a horizontal cross-section of the nozzle hole 124b is tapered in the air injection direction and then is increased. Thus, the speed of injected air may be increased, and the range of injection may be widened (e.g., enlarged).

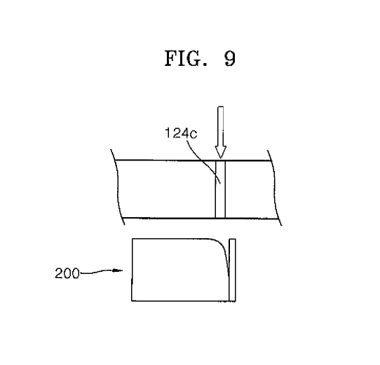

FIG. 9 illustrates an example in which the nozzle hole 124c is formed to have a uniform horizontal cross-section in the air injection direction. The nozzle hole 124 of FIG. 7 and the nozzle hole 124b of FIG. 8 are favorable to inject air intensively (e.g., at high pressure) onto a part of the battery 200 that is vulnerable to leakage, whereas the nozzle hole 124c of FIG. 9 is favorable to inject air uniformly onto the entire side of the battery 200 (see e.g., FIG. 1).

The following Table 1 shows results of detecting a leak that occurs in a battery using the apparatus 100 illustrated in FIG. 1, according to an embodiment of the present invention.

In Table 1, holes were formed (to simulate leakage) in a terrace part T, a first wing part L, a second wing part R, and a bottom part B of the battery using a microdrill having a diameter of 0.05 mm. Here, the bottom part B refers to an opposite side to the terrace part T.

18 batteries each including the terrace part T, the first wing part L, the second wing part R or the bottom part B in which holes were formed, were divided into two groups G each including 9 batteries, and test was conducted twice by varying pressure and duration (e.g., time) of air applied to 9 batteries of each group G. Also, although leak formation positions were different, test was conducted simultaneously on 9 batteries placed in the same ‘row’ of Table 1 and having the same air injection pressure and injection time.

In Table 1, \textcircled{∘} represents a case in which the occurrence of swelling of the battery is clear, ◯ represents a case in which deformation that may be inspected by the naked eye occurs due to filling air in the battery, and Δ represents a level at which a defect of the battery may be determined due to deformation of a pouch that exists in the surface of the battery even though swelling of the battery is not clear, i.e., all cases in which a leak may be detected.

TABLE 1

| | | | | | | Second | | | |
|---|---|---|---|---|---|---|---|---|---|
| Injection | Injection | Terrace | | First wing | | wing | | Bottom | |
| pressure | time | part T | | part L | | part R | | part B | |
| (MPa) | (sec) | G1 | G2 | G1 | G2 | G1 | G2 | G1 | G2 |
| 0.3 | 3 | ◯ | ◯ | ⊚ | ◯ | ◯ | ◯ | ◯ | ◯ |
| | 4 | ◯ | ◯ | ⊚ | ◯ | ◯ | ◯ | ⊚ | ⊚ |
| | 5 | ⊚ | ⊚ | ⊚ | ⊚ | ◯ | ⊚ | ⊚ | ⊚ |
| 0.4 | 3 | ⊚ | ◯ | ⊚ | Δ | ⊚ | ◯ | ◯ | ◯ |
| | 4 | ⊚ | ◯ | ◯ | ◯ | ◯ | ⊚ | ⊚ | ◯ |
| | 5 | ⊚ | ◯ | ⊚ | ◯ | ⊚ | ⊚ | ⊚ | ◯ |
| 0.5 | 3 | ⊚ | ◯ | ⊚ | ◯ | ⊚ | ⊚ | ◯ | ◯ |
| | 4 | ⊚ | ⊚ | ⊚ | ⊚ | ⊚ | ⊚ | ⊚ | ◯ |
| | 5 | ⊚ | ◯ | ⊚ | ⊚ | ⊚ | ⊚ | ◯ | ⊚ |

As shown in Table 1, in the apparatus 100 for inspecting the leak of the battery 200 illustrated in FIG. 1, even when a leak occurs in any part of four edges of the battery 200, leak detection may be possible.

The following Table 2 shows results of inspecting the leak using the apparatus 100 according to an embodiment illustrated in FIG. 1 (Embodiment, referred to in Table 2 as “Embod.”) and results of inspecting the occurrence of a leak by putting a battery into a sealed chamber, pressurizing an inside of the chamber and then by blowing air, according to the related art (Comparative Example, referred to in Table 2 as “Comp. Example”).

In the following Table 2, in both of the Embodiment and Comparative Example, holes were formed in a terrace part, wing parts, and a bottom part of the same battery using a microdrill having a diameter of 0.05 mm so as to create a leak. Here, the bottom part means an opposite side to the terrace part. Also, in Tests 1 through 3, 18 batteries were divided into 3 groups each including 6 batteries and then holes were formed in the terrace part, the wing parts, or the bottom part according to group.

In the Embodiment, air was injected under an injection pressure of 0.5 MPa for 4 seconds, and in Comparative Example, the inside of the chamber was pressurized at 1 MPa, the chamber was opened, and air was blown for 3 seconds.

TABLE 2

| | | Test 1 | | Test 2 | | Test 3 | |
|---|---|---|---|---|---|---|---|
| Position at | | | Comp. | | Comp. | | Comp. |
| which leak | | | Exam- | | Exam- | | Exam- |
| occurs | | Embod. | ple | Embod. | ple | Embod. | ple |
| Terrace | 1 | ◯ | X | ◯ | ◯ | ◯ | X |
| part | 2 | ◯ | ◯ | ◯ | ◯ | ◯ | ◯ |
| | 3 | ◯ | ◯ | ◯ | X | ◯ | ◯ |
| | 4 | ◯ | ◯ | ◯ | X | ◯ | ◯ |
| | 5 | ◯ | ◯ | ◯ | ◯ | ◯ | X |
| | 6 | ◯ | X | ◯ | ◯ | ◯ | ◯ |
| Wing | 1 | ◯ | ◯ | ◯ | ◯ | ◯ | X |
| parts | 2 | ◯ | ◯ | ◯ | ◯ | ◯ | ◯ |
| | 3 | ◯ | X | ◯ | ◯ | ◯ | ◯ |
| | 4 | ◯ | X | ◯ | X | ◯ | X |
| | 5 | ◯ | ◯ | ◯ | X | ◯ | ◯ |
| | 6 | ◯ | ◯ | ◯ | ◯ | ◯ | ◯ |
| Bottom | 1 | ◯ | X | ◯ | ◯ | ◯ | X |
| part | 2 | ◯ | ◯ | ◯ | ◯ | ◯ | X |
| | 3 | ◯ | ◯ | ◯ | X | ◯ | ◯ |
| | 4 | ◯ | ◯ | ◯ | X | ◯ | ◯ |
| | 5 | ◯ | X | ◯ | ◯ | ◯ | ◯ |
| | 6 | ◯ | X | ◯ | ◯ | ◯ | X |

| | | | | | | |
|---|---|---|---|---|---|---|
| Results of | 100% | 61% | 100% | 67% | 100% | 61% |
| detection | | | | | | |

As shown in Table 2, the apparatus 100 for inspecting the leak of the battery 200, according to an embodiment illustrated in FIG. 1, has a leak detection ability of 100% and thus has an excellent detection ability compared to the related art.

As described above, according to the one or more of the above embodiments of the present invention, because a leak of a battery can be inspected under an atmospheric pressure, the configuration of an apparatus for inspecting a leak of the battery can be simplified, and an inspection time can be reduced.

73583/S744

In addition, because air is injected onto one side of the battery at high speed and a state of the leak of the battery is inspected, a plurality of batteries can be simultaneously inspected, and a leak detection ability of the apparatus can be improved.

The effects of the present invention will be inferred from the following description with reference to the drawings in addition to the above-mentioned matters.

It should be understood that the exemplary embodiments described therein should be considered in a descriptive sense only and not for purposes of limitation. Descriptions of features or aspects within each embodiment should typically be considered as available for other similar features or aspects in other embodiments. It will be understood by those of ordinary skill in the art that various suitable changes in form and detail may be made therein without departing from the spirit and scope of the present invention as defined by the following claims, and equivalents thereof.

What is claimed is:

1. An apparatus for inspecting a leak of a battery, the apparatus comprising:
a jig on which a battery is mounted;
a first plate comprising nozzle parts configured to inject air;
a second plate configured to support the jig and the first plate; and
a first driving unit positioned on the second plate and configured to move the jig,
wherein the jig is moved by the first driving unit to a position at which the jig overlaps the first plate.

2. The apparatus of claim 1, wherein the nozzle parts are configured to inject air in a direction of the jig when the jig overlaps the first plate.

3. The apparatus of claim 2, wherein each of the nozzle parts comprises a plurality of nozzle holes, and
wherein the plurality of nozzle holes are positioned to be spaced from each other by a gap.

4. The apparatus of claim 3, wherein a horizontal cross-section of each of the nozzle holes is tapered in a direction of air injection.

5. The apparatus of claim 3, wherein the battery comprises an electrode assembly and a pouch accommodating the electrode assembly,
wherein the pouch comprises a pair of side wing parts and a terrace part formed by fusion bonding, and
wherein the plurality of nozzle holes are positioned to inject the air onto at least the pair of side wing parts and the terrace part.

6. The apparatus of claim 5, wherein the pair of side wing parts are bent in one direction, concave parts are between the pair of side wing parts and sides of the battery, and the nozzle holes are positioned to correspond to positions of the concave parts.

7. The apparatus of claim 1, wherein the jig comprises a mounting part, and the battery is mounted within the mounting part.

8. The apparatus of claim 1, wherein the jig comprises a plurality of mounting parts.

9. The apparatus of claim 1, further comprising a second driving unit configured to adjust a height of the first plate.

10. The apparatus of claim 1, further comprising a guide part positioned on the second plate for limiting a movement range of the jig.

11. The apparatus of claim 1, wherein the jig is positioned below the first plate to overlap the first plate.

12. The apparatus of claim 1, wherein the nozzle parts inject the air under an atmospheric pressure.

13. A method of inspecting a leak of a battery, the method comprising:
mounting a battery on a jig;
moving the jig to overlap a first plate comprising nozzle parts; and
injecting air onto the battery using the nozzle parts,
wherein the battery comprises a pouch accommodating an electrode assembly,
wherein the pouch comprises a pair of side wing parts and a terrace part formed by fusion bonding, and
wherein the nozzle parts are configured to inject the air onto at least the pair of side wing parts and the terrace part.

14. The method of claim 13, wherein the nozzle parts inject the air under an atmospheric pressure.

15. The method of claim 13, wherein a plurality of nozzle holes are formed in each of the nozzle parts, and
a horizontal cross-section of each of the nozzle holes is tapered in a direction of air injection.

16. The method of claim 13, wherein the pair of side wing parts are bent in one direction, concave parts are formed between the pair of side wing parts and sides of the battery, and the air is injected onto the concave parts.

17. The method of claim 13, wherein a mounting part is on the jig, and the battery is mounted within the mounting part.

18. The method of claim 13, wherein a plurality of mounting parts are on the jig.

19. The method of claim 13, further comprising adjusting a height of the first plate before injecting the air.

20. The method of claim 13, further comprising determining whether a leak occurs in the battery based on swelling of the battery after injecting the air.
